(19) United States
(12) Patent Application Publication
(10) Pub. No.: US 2006/0291192 A1
(43) Pub. Date: Dec. 28, 2006

(54) Illuminating garment system and method of use

(76) Inventor: Roy Hill, Boulder City, NV (US)

Correspondence Address: GREENBERG TRAURIG, 3773 HOWARD HUGHES PARKWAY, SUITE 500 NORTH, LAS VEGAS, NV, 89109, US

(21) Appl. No.: 11/166,366

(22) Filed: Jun. 24, 2005

(51) Int. Cl. F21V 21/108

(52) U.S. Cl. 362/108

(57) ABSTRACT

An illuminating garment for making people more visible is disclosed. One or more illumination members and a power source provide a means for illuminating the garment. Pedestrians, construction workers, crossing-guard, motorcyclists and bicyclists are just a few examples of persons which benefit from the illuminated garment. More particularly, a motorcyclist version includes illumination members electrically connected to the motorcycle's brake and turn signal light system. Accordingly, as the motorcyclist operates the brakes and turn signals, a corresponding light source of the garment illuminates in unison with the motorcycle's brake light and turn signals, respectively. A similar system for bicyclists includes a control unit for the bicyclist to enter brake and turn commands. In one version, the illumination members comprise a series of light-emitting diodes.

### FIELD OF THE INVENTION

The embodiments of the present invention relate to a garment providing means for making a wearer more visible. More particularly, the embodiments of the present invention are directed to a garment which incorporates illumination members for making a wearer, and his or her intentions, more visible.

### BACKGROUND

Because the persons are not highly visible, many activities can be dangerous for the persons participating in them. For example, motorcycle and bicycle riders, highway construction workers and crossing-guards are often injured or killed by motorists who fail to notice them until it is too late. Adding to the problem is the complication of everyday life. That is, motorists are often concentrating on multiple tasks unrelated to driving (e.g., talking on a cellular telephone) and therefore are distracted as they drive.

According to national statistics, there are, on average, approximately 10,000 motorcyclists, bicyclists and pedestrians killed annually by motor vehicles. Countless others are injured. While the exact figures are not known, it is apparent that many of the accidents could have been prevented had the victim been more visible to the operator of the motor vehicle.

Currently, motorcyclists, bicyclists, pedestrians, crossing-guards and highway construction workers use florescent colors and/or blinking lights to make themselves more visible. For example, a bicyclist may wear a florescent colored vest and use blinking red lights secured to a front and/or rear of the bicycle to attract the attention of passing motorists. While such a combination of precautions render the bicyclist more visible, often times, it is not enough. Motorcyclists are even more prone to accidents as they must maneuver city and highway streets hidden amongst all other motor vehicles, including automobiles, SUVs and commercial trucks.

Based on the national statistics there continues to be the need for a system of making certain people more visible to motorists. This is especially true for motorcyclists, bicyclists, crossing-guards, pedestrians and highway construction workers.

### SUMMARY

Accordingly, the embodiments of the present invention are directed to a garment (e.g., vest) incorporating a series of highly visible illumination members. For pedestrians, crossing-guards and highway construction workers, the illumination members may be powered by a dedicated battery source. For motorcyclists, the illumination members may be powered by the motorcycle battery. For bicyclists, the illumination members may be powered by a dedicated battery source or with energy generated by the bicyclist.

In an embodiment ideal for motorcyclists, the one or more illumination members, comprising one or more individual light sources (e.g., light-emitting diodes), are powered by the motorcycle battery. In one embodiment, one illumination member includes a series of red light sources which act as brake lights and a second illumination member includes a series of yellow light sources which act as running lights and turn signals. Electrical connections between the illumination members and the brake light wire and turn signal wires of the motorcycle causes the red and yellow light sources of the illumination members to illuminate in unison with the brake lights and turn signals, respectively, of the motorcycle. The illumination members may be positioned on the front, rear and/or both the front and rear of the garment. In such configurations, the motorcyclist is highly visible at all times, notably during dangerous driving situations such as turning the motorcycle left into oncoming traffic or where traffic is turning left into the path of the motorcycle.

It will be apparent to those skilled in the art that the embodiments of the present invention are not limited to pedestrians, crossing-guards, construction workers, motorcyclists and bicyclists and may benefit other users, including professional divers, commercial fisherman and skydivers as well. Other features, variations and embodiments will become evident from the detailed description, drawings and claims set forth below.

### BRIEF DESCRIPTION OF THE DRAWINGS

FIG. 1 shows a rear view of a motorcyclist's garment of the present invention;

FIG. 2 shows a top view of light-emitting diodes attached to a portion of a flexible circuit strip;

FIG. 3 shows the components of the motorcyclist's garment of the present invention;

FIG. 4 shows an alternative rear view of the motorcyclist's garment of the present invention;

FIG. 5 shows a second alternative rear view of the motorcyclist's garment of the present invention; and

FIG. 6 shows a control unit for a bicyclist's garment of the present invention.

### DETAILED DESCRIPTION

The detailed description below is directed to garments for a motorcyclist and bicyclist. However, it should be understood that the embodiments disclosed hereinafter are not limited in their application to a motorcyclists or bicyclists but contemplate garments for pedestrians, crossing-guards, highway construction workers and similarly situated persons. Also, it should be understood that the phraseology and terminology employed herein are for the purpose of describing the embodiments of the present invention and are not intended to limit the scope of the invention in any way.

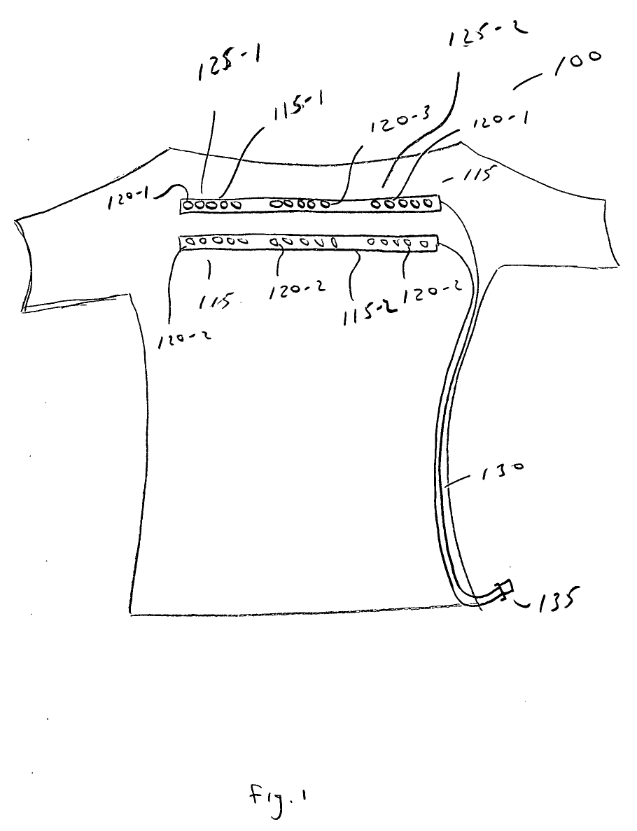

Reference is now made to the figures wherein like parts are referred to by like numerals throughout. FIG. 1 shows a rear view of motorcyclist's garment generally referred to by reference numeral 100. As shown in FIG. 1, the garment 100 is fabricated of an optional opaque background material 105 with an overlaid fish-net material permitting light sources to illuminate therethrough. Other garment materials are conceivable as well.

One or more illumination members 115 comprise one or more light-emitting diodes 120. An upper illumination member 115-1 comprising yellow LEDs 120-1 serves as running lights and turn signals while a lower illumination member 115-2 comprising red LEDs 120-2 serves as a brake indicator. Accordingly, in practice, as a motorcycle rider operates the brakes of the motorcycle, the LEDs 120-2 of the lower illumination member 115-2 illuminate in unison with the motorcycle's own factory brake lights. Similarly, as the rider operates the left and right turn signals of the motorcycle, a left portion 125-1 and right portion 125-2, respectively, of the LEDs 120-1 of the upper illumination member 115-1 illuminate and blink in unison with the motorcycle's turn signals. A center portion of LEDs 120-3 of the upper illumination member 115-1 remains illuminated to cause the rider to be more visible at all times. Wires 130 lead from the illumination members 115-1 and 115-2 to a connector plug 135.

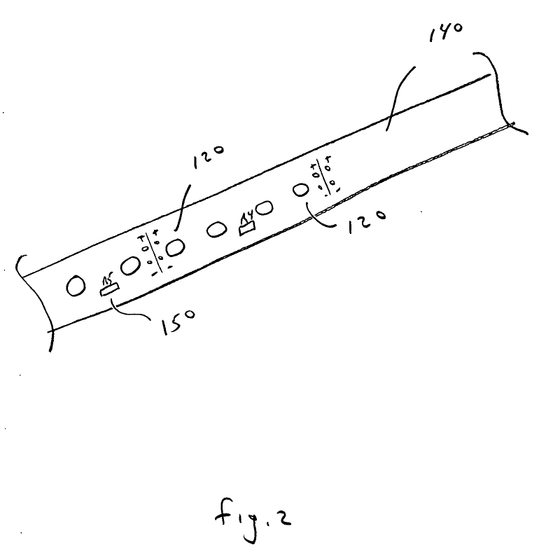

For convenience, as shown in FIG. 2, a flexible circuit board 140 supports the yellow LEDs 120-1 and red LEDs 120-2 forming the upper illumination member 115-1 and lower illumination member 115-2. The flexible circuit board 140 incorporates electrical leads which permit power to flow to each of the LEDs from a power source (e.g., motorcycle battery), and electrical components, including resistors 150, necessary to control the flow and magnitude of the supplied electrical power. Preferably, the flexible circuit board 140 is waterproof to prevent failure during wet weather. As disclosed below, the circuit board 140 further facilitates operation of the LEDs in response to electrical signals received from electrical connections with the motorcycle's wiring. In other embodiments, it is conceivable that a rigid circuit board may be used. Although not shown in the figures, ideally, the wires 130 and circuit boards 140 are concealed by a seam, fabric strip or some other manner to maintain an aesthetic design. Therefore, only the LEDs are observable.

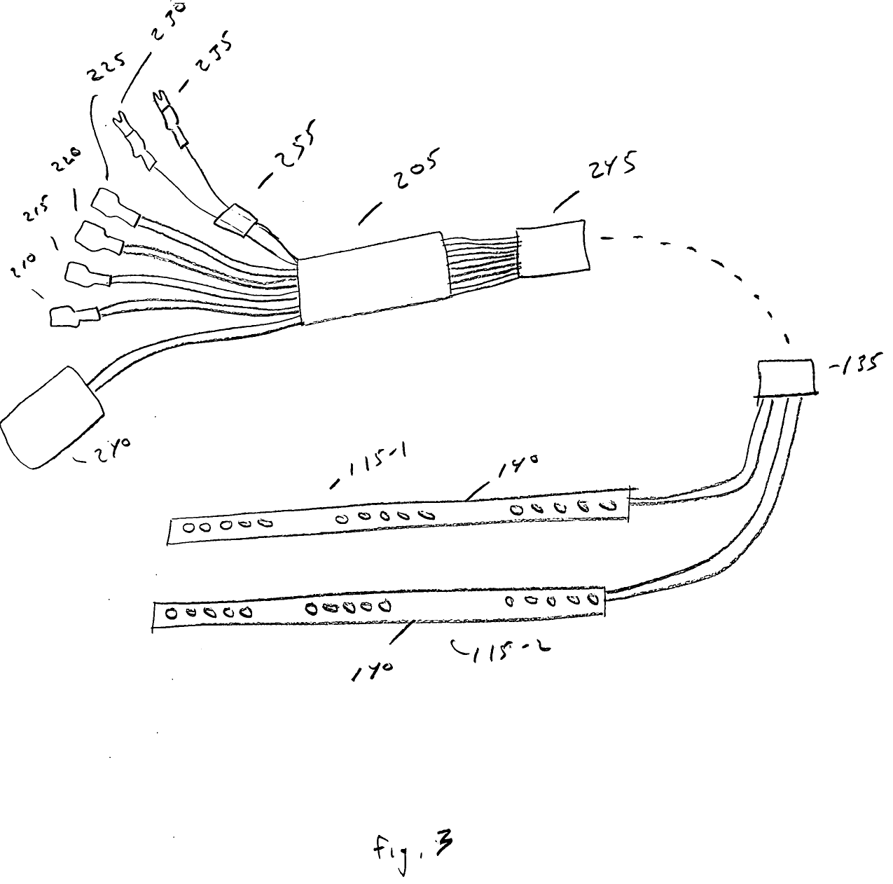

Now referring to FIG. 3, a configuration of components for operating and controlling a motorcycle embodiment of the present invention is shown. A primary wire bundle 205 comprises a brake input wire 210, left turn signal input wire 215, right turn signal input wire 220 and ground wire 225. Each of the input wires and ground wire is connected to a corresponding wire on the motorcycle. Specifically, the brake input wire 210 is connected to the brake light bulb wire, the turn signal input wires 210 and 220 are connected to the turn signal bulb wires and the ground wire 220 is connected to the ground wire of the motorcycle. The wire bundle 205 further includes a positive electrode 230 and negative electrode 235 for connecting the entire device to the motorcycle's battery. An optional blinker module 240 allows a rider to independently control the left portion 125-1 and right portion 125-2 of the upper illumination member 115-1. In other words, the motorcycle's turn signals may blink at a first rate while the LEDs 120-1 may be programmed to blink at a different rate. Multiple blink rates tend to attract the attention of other motorists. The wire bundle 205 and blinker module 240 are ideally installed under the seat of the motorcycle such that a connector plug 245 may extend from under the seat to a point proximate the rider.

The upper illumination member 115-1 and lower illumination member 115-2 and supporting flexible circuit boards 140 form part of the motorcyclist's garment. A connector plug 135 joins the upper illumination member 115-2 and lower illumination member 115-2 to the motorcycle's battery and wiring by engaging the connector plug 245 thereby completing the system. The connector plug 145 may be on the end of an elongated system of wires to permit a rider to get off the motorcycle and then disconnect the engaged plugs 135, 245. This prevents riders from accidentally damaging the system by getting off the motorcycle without forts disconnecting the engaged plugs 135, 245. An inline fuse 255 prevents the wiring from being damaged by a surge is electrical power.

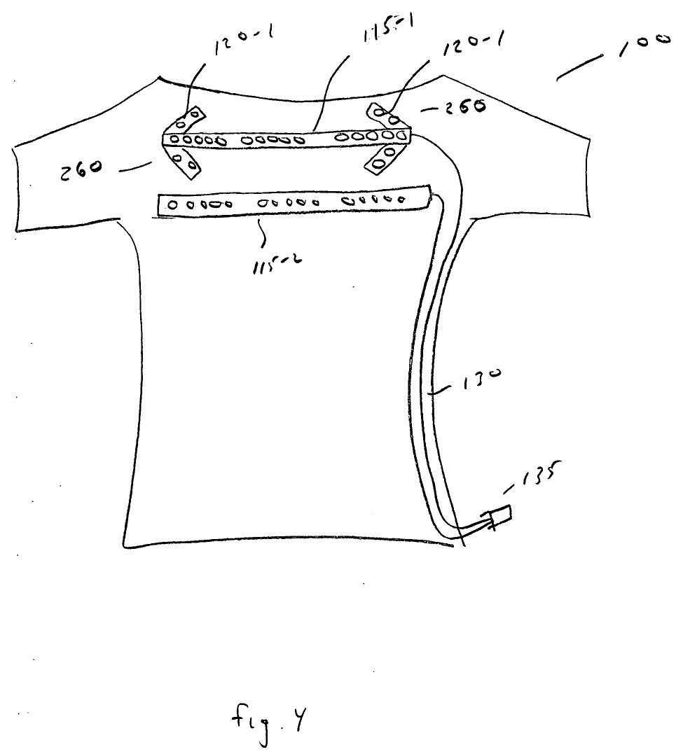

FIG. 4 shows an alternative rear view of a motorcyclist's garment wherein the LEDs 120-1 of the upper illumination member 115-1 are positioned in the shape of arrows 260 to more dramatically alert other motorists of the motorcyclist's intention.

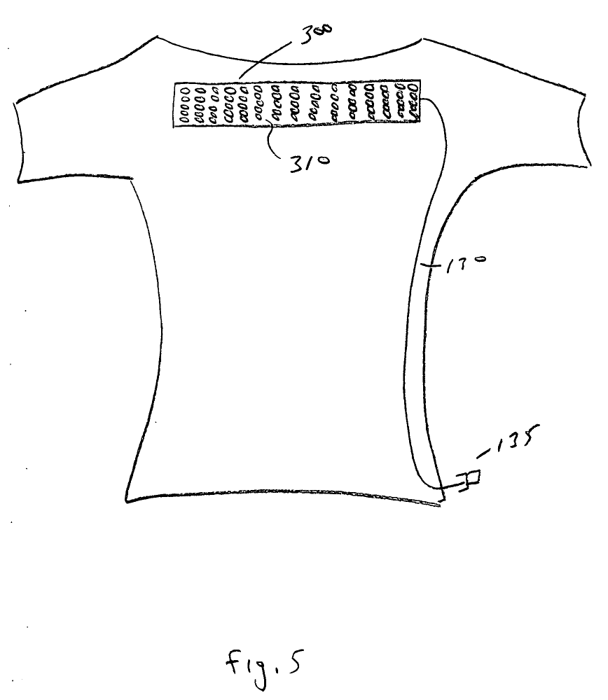

FIG. 5 shows yet another alternative rear view of a motorcyclist's garment having a scrolling message display 300. Motorcyclists are able to manually input messages, including intentions (e.g., left hand turn), informational and promotional messages, for display. The scrolling message display 300 comprises an array of LEDs 310 in communication with a controller. The controller causes the programmed messages to be scrolled across the scrolling message display 300.

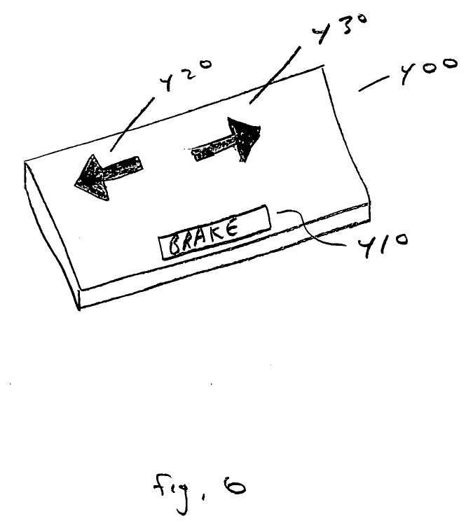

FIG. 6 shows a control unit 400 for a bicycle embodiment of the present invention. The bicycle embodiment is similar to the motorcycle embodiment except that the bicycle does not incorporate brake lights or turn signals and the corresponding electrical wiring. Accordingly, the control unit 400 is mounted to a convenient location on the bicycle such that the bicyclist may enter the appropriate command as needed. The control unit 400 includes a brake command button 410, left turn signal command button 420 and right turn command button 430 which operate the one or more illumination members. As with the motorcycle embodiment, pre-established LEDs serve as running lights and remain illuminated at all times. Powering the control unit 400 and the one or more illumination members is accomplished using a battery source or energy generated by the bicyclist. A storage unit in contact with a tire or axle of the bicycle converts and stores rotational energy in the form of electrical energy. The electrical energy is then transmitted to power the control unit 400 and the one or more illumination members.

In alternative designs, solar panels integrated into the rider's clothing or helmet powers the system. Solar panels may be positioned in any location, including on the rider's apparel, helmet of the motorcycle or bicycle being ridden, so that they are able to collect solar energy and power the system.

Although the invention has been described in detail with reference to several embodiments, additional variations and modifications exist within the scope and spirit of the invention as described and defined in the following claims.

I claim:

1. A system for making people more visible comprising:
a garment to be worn by a user, said garment to be worn over said user's torso area;
a power source; and
one or more illumination members connectable to said power source and attached to said garment such that when activated said one or more illumination members are visible to others.

2. The apparatus of claim 1 wherein said garment is selected from a group consisting of a jacket, vest, shirt and coat.

3. The apparatus of claim 1 wherein said power source is a battery.

4. The apparatus of claim 1 wherein the one or more illumination members comprise one or more light-emitting diodes.

5. The apparatus of claim 4 wherein the one or more light-emitting diodes are connected to a flexible circuit board.

6. The apparatus of claim 4 wherein the one or more light-emitting diodes are connected to a rigid circuit board.

7. The apparatus of claim 1 wherein said power source is one or more solar panels.

8. A system for making a motorcyclist, and his or her driving intentions, more visible comprising:
a garment wearable over said motorcyclist's torso area;
a power source;
one or more illumination members incorporated into said garment, portions of said illumination members illuminating in response to the motorcyclist operating brakes and/or turn signals of a motorcycle being ridden by said motorcyclist.

9. The system of claim 8 wherein the power source comprises a battery of the motorcycle.

10. The system of claim 9 wherein an illumination member connector plugs into a connector in electrical communication with the battery of the motorcycle.

11. The system of claim 8 wherein said power source is one or more solar panels.

12. The system of claim 8 wherein a first illumination member comprises a series of red light-emitting diodes attached to a flexible circuit board in electrical communication with a brake light wire of the motorcycle such that said red light-emitting diodes illuminate in response to the motorcyclist operating the brakes of the motorcycle.

13. The system of claim 8 wherein a second illumination member comprises a series of yellow light-emitting diodes attached to a flexible circuit board in electrical communication with turn signal light wires of the motorcycle such that said yellow light-emitting diodes illuminate in response to the motorcyclist operating the turn signals of the motorcycle.

14. The system of clam 13 wherein the second illumination member further comprises a first arrow pointing left and a second arrow pointing right, said arrows formed of yellow light-emitting diodes.

15. A method of making a motorcyclist, and his or her driving intentions, more visible to others comprising:
attaching one or more illumination members to a garment;
providing a power source for illuminating said one or more illumination members; and
electrically connecting said one or more illumination members to a brake light wire and/or turn signal wires of a motorcycle such that portions of said illumination members illuminate in response to the motorcyclist operating brakes and/or turn signals of the motorcycle.

16. The method of claim 15 further comprising attaching a plurality of light-emitting diodes to flexible circuit boards to form the one or more illumination members.

17. The method of claim 15 further comprising providing an illumination member connector and motorcycle battery connector for providing power to said one or more illumination members.

18. The method of claim 15 further comprising forming turn signals on said garment using said one or more illumination members.

19. The method of claim 15 further comprising providing one or more solar panels for powering the illumination members.

20. A system for making a bicyclist, and his or her riding intentions, more visible comprising:
a garment wearable over said bicyclist's torso area;
a power source;
one or more illumination members incorporated into said garment, portions of said illumination members illuminated in response to said bicyclist entering a brake and/or turn command.

21. The system of claim 20 further comprising a control unit having one or more input means for the bicyclist to enter the brake and/or turn command.

22. The system of claim 20 wherein the power source is a generator and storage unit in contact with a tire or axle of the bicycle.

23. The system of claim 20 wherein said power source is one or more solar panels.
